(19) United States
(12) Patent Application Publication
(10) Pub. No.: US 2021/0139019 A1
(43) Pub. Date: May 13, 2021

(54) DRIVING ASSISTANCE APPARATUS

(71) Applicant: TOYOTA JIDOSHA KABUSHIKI KAISHA, Toyota-shi (JP)

(72) Inventors: Shogo ITO, Sunto-gun (JP); Kohei TOCHIGI, Sunto-gun (JP); Yuta IKEZAWA, Susono-shi (JP)

(21) Appl. No.: 17/083,711

(22) Filed: Oct. 29, 2020

(30) Foreign Application Priority Data
Nov. 13, 2019 (JP) 2019-205299

(51) Int. Cl. B60W 30/09; G08G 1/056; G06K 9/00

(52) U.S. Cl. CPC B60W 30/09; G08G 1/056; B60W 2554/404; B60W 2552/10; G06K 9/00825

(57) ABSTRACT

A driving assistance apparatus includes: a recognition unit that recognizes a lighting and a progressing-permitted direction of an arrow type traffic signal based on an external sensor; a comparison unit that compares the progressing-permitted direction with a scheduled progressing direction of a vehicle; an assistance unit that performs a driving assistance based on a result of comparison performed by the comparison unit; a determination unit that determines a travel state of a surrounding vehicle of the vehicle based on the external sensor; and an estimation unit that estimates the progressing-permitted direction of the arrow type traffic signal based on a result of determination performed by the determination unit, wherein the comparison unit compares the progressing-permitted direction and the scheduled progressing direction of the vehicle, when the lighting of the arrow type traffic signal is recognized by the recognition unit and the progressing-permitted direction is not recognized.

### CROSS-REFERENCE TO RELATED APPLICATION

This application is based on Japanese Patent Application No. 2019-205299 filed with Japan Patent Office on Nov. 13, 2019, the entire contents of which are hereby incorporated by reference.

### TECHNICAL FIELD

The present disclosure relates to a driving assistance apparatus.

### BACKGROUND

Japanese Unexamined Patent Publication No. 2019-016000 discloses an apparatus that performs a driving assistance based on a result of recognition of a traffic signal capable of lighting arrow signals. This apparatus compares the direction of the arrow signal with the progressing direction of the vehicle, and when the two directions do not coincide with each other, performs the driving assistance. The driving assistance is a warning control. This apparatus performs a deceleration control when the vehicle continues to enter an intersection in spite of the warning.

### SUMMARY

Incidentally, when an arrow signal is recognized from a distance, the shape of the arrow signal (pointing direction) may not be recognized even if the lighting of the arrow signal is recognized. Therefore, the apparatus described in Japanese Unexamined Patent Publication No. 2019-016000 recognizes the direction of the arrow signal at a position closer to the traffic signal than the position where the lighting of the arrow signal can be recognized, and starts the driving assistance. Therefore, an occupant who has recognized the lighting of the arrow signal may feel a delay in the assistance timing.

In order to solve such a problem, it is conceivable to perform the driving assistance based on the lighting of the arrow signal. However, the driving assistance apparatus may start the driving assistance while the direction of the arrow signal remains uncertain. Therefore, the driving assistance based on the lighting of the arrow signal may become an unnecessary assistance as a result. If such an unnecessary assistance occurs frequently, the occupant may feel inconvenience.

An object of the present disclosure is to provide a driving assistance apparatus capable of expediting the assistance timing and reducing the inconvenience to the occupant in the driving assistance based on the result of recognition of the traffic signal capable of lighting the arrow signal.

An aspect of the present disclosure is to provide a driving assistance apparatus that assists driving of a vehicle that is traveling toward a traffic signal capable of lighting an arrow signal indicating a progressing-permitted direction. The driving assistance apparatus includes a recognition unit, a comparison unit, an assistance unit, a determination unit, and an estimation unit. The recognition unit is configured to recognize a lighting and a progressing-permitted direction of the arrow type traffic signal based on a result of detection performed by an external sensor that detects information on an external environment of the vehicle. The comparison unit is configured to compare the progressing-permitted direction recognized by the recognition unit with a scheduled progressing direction of the vehicle. The assistance unit is configured to perform a driving assistance based on a result of comparison performed by the comparison unit. The determination unit is configured to determine a travel state of a surrounding vehicle of the vehicle based on a result of detection performed by the external sensor. The estimation unit is configured to estimate the progressing-permitted direction of the arrow type traffic signal based on a result of determination performed by the determination unit. The comparison unit is configured to compare the progressing-permitted direction estimated by the estimation unit and the scheduled progressing direction of the vehicle, when the lighting of the arrow type traffic signal is recognized by the recognition unit and the progressing-permitted direction is not recognized.

In the driving assistance apparatus, the lighting of the arrow signals and the progressing-permitted direction are recognized by the recognition unit. The progressing-permitted direction and the scheduled progressing direction of the vehicle are compared by the comparison unit. The driving assistance is performed by the assistance unit based on the result of comparison. However, in some cases, the recognition unit can recognize the lighting of the arrow signals, but cannot recognize the progressing-permitted direction of the arrow signals. Therefore, when the lighting of the arrow signals is recognized and the progressing-permitted direction is not recognized, the progressing-permitted direction estimated by the estimation unit and the scheduled progressing direction of the vehicle are compared by the comparison unit. The travel state of the surrounding vehicle of the vehicle is determined by the determination unit based on the result of detection performed by the external sensor. The progressing-permitted direction of the arrow type traffic signal is estimated by the estimation unit based on the result of determination performed by the determination unit. In this way, even if the progressing-permitted direction is not recognized, the driving assistance apparatus predicts the progressing-permitted direction of the arrow signal signals based on the travel state of the surrounding vehicle, and can perform the driving assistance based on the result of prediction. Therefore, the driving assistance apparatus can expedite a timing of the assistance compared to a case where the assistance is performed from the timing at which the progressing-permitted directions of the arrow signals are recognized. Furthermore, the driving assistance apparatus can reduce a case where the performed assistance becomes an unnecessary assistance as a result compared to a case where the assistance is performed without taking the progressing-permitted direction of the arrow signal into consideration. Accordingly, the driving assistance apparatus can reduce the inconvenience to the occupant.

In an embodiment, the estimation unit may be configured to estimate the progressing-permitted direction of the arrow type traffic signal based on the number of road lanes on a road on which the vehicle travels, the number of lightings of the arrow type traffic signal, and the travel state of the surrounding vehicle. In this case, the driving assistance apparatus can estimate the progressing-permitted direction of the arrow type traffic signals based on the behavior of the surrounding vehicle in the travel scene including the number of lanes and the number of lightings.

According to various aspects and embodiment of the present disclosure, in the driving assistance based on the result of recognition of the traffic signal capable of lighting the arrow signals, the assistance timing can be expedited and the inconvenience to the occupant can be reduced.

### BRIEF DESCRIPTION OF THE DRAWINGS

FIG. 1 is a functional block diagram of an example of a vehicle including a driving assistance apparatus according to an embodiment.

FIGS. 2A to 2D are examples of lighting of a traffic signal.

FIGS. 3A to 3D are examples of lighting of a traffic signal.

FIG. 4 is a diagram illustrating an example of an intersection where a traffic signal is used.

FIG. 5 is a flowchart illustrating an example of an operation performed by the driving assistance apparatus.

### DETAILED DESCRIPTION

Hereinafter, an exemplary embodiment will be described with reference to the drawings. In the description below, the same reference numerals will be used for the same or equivalent elements, and redundant explanations will not be repeated.

### Configuration of Vehicle and Driving Assistance Apparatus

FIG. 1 is a functional block diagram of an example of a vehicle 2 including a driving assistance apparatus 1 according to an embodiment. As illustrated in FIG. 1, the driving assistance apparatus 1 is mounted on the vehicle 2 such as a passenger car, and assists the driving of the vehicle 2 that travels toward a traffic signal capable of lighting an arrow signal indicating a progressing-permitted direction. The arrow signal indicates an arrow when lighting, and indicates the progressing-permitted direction by a shape of the arrow (the direction indicated and pointed by the arrow). The progressing-permitted direction is the direction in which the progressing of the vehicle is permitted. Details of the traffic signal will be described later. The vehicle 2 includes an external sensor 3, a GPS receiver 4, an internal sensor 5, a map database 6, a navigation system 7, an actuator 8, a notification unit 9, and an assistance ECU (Electronic Control Unit) 10.

The external sensor 3 is a detection device that detects information on an external environment of the vehicle 2. The external environment is a position of an object around the vehicle 2, a situation of the object, or the like. The result of detection by the external sensor 3 includes the position, shape, color, and the like of the object in front of a vehicle road on which the vehicle 2 travels. The object includes vehicles, pedestrians, traffic signals, road paint, and the like. A camera is the external sensor 3 as an example.

The camera is an imaging device that images an external situation of the vehicle 2. As an example, the camera is provided, for example, on an inner side of windshield of the vehicle 2. The camera acquires imaging information relating to the external situation of the vehicle 2. The camera may be a monocular camera or may be a stereo camera. The stereo camera has two imaging units that are arranged to reproduce a binocular parallax. The information relating to the depth direction is also included in the imaging information by the stereo camera.

The external sensor 3 is not limited to a camera and may be a radar sensor or the like. The radar sensor is a detection device that detects objects around the vehicle 2 using radio waves (for example, millimeter waves) or light. The radar sensor includes, for example, millimeter wave radar or a laser imaging detection and ranging (LIDAR). The radar sensor transmits the radio wave or light to the surroundings of the vehicle 2, and detects the objects by receiving radio waves or light reflected from objects.

The GPS receiver 4 receives signals from three or more GPS satellites and acquires position information indicating the position of the vehicle 2. The position information includes, for example, latitude and longitude. Instead of the GPS receiver 4, other means that can specify the latitude and longitude where the vehicle 2 exists may be used.

The internal sensor 5 is a detection device that detects a travel state of the vehicle 2. The internal sensor 5 includes a vehicle speed sensor, an acceleration sensor, and a yaw rate sensor. The vehicle speed sensor is a measuring device that measures a speed of the vehicle 2. As the vehicle speed sensor, for example, a vehicle wheel speed sensor is used, which is provided on vehicle wheels of the vehicle 2 or on a drive shaft rotating integrally with vehicle wheels, and measures a rotational speed of the vehicle wheels.

The acceleration sensor is a measuring device that measures an acceleration of the vehicle 2. The acceleration sensor may include, for example, a longitudinal acceleration sensor that measures acceleration in the longitudinal direction of the vehicle 2 and a lateral acceleration sensor that measures lateral acceleration of the vehicle 2. The yaw rate sensor is a measuring device that measures a yaw rate (rotation angular velocity) around the vertical axis at the center of gravity of the vehicle 2. As the yaw rate sensor, for example, a Gyro sensor can be used.

The map database 6 is a storage device storing the map information. The map database 6 is stored, for example, in a hard disk drive (HDD) mounted on the vehicle 2. As the map information, the map database 6 includes information on stationary objects, traffic rules, positions of traffic signals, and the like. The stationary objects are, for example, road surface paint (including lane boundaries such as lane lines and yellow lines) and structures (curves, poles, electric poles, buildings, signs, trees, and the like). A part of the map information included in the map database 6 may be stored in a storage device different from the HDD in which the map database 6 is stored. A part or all of the map information included in the map database 6 may be stored in a storage device other than a storage device provided in the vehicle 2.

The navigation system 7 is a system that guides a driver of the vehicle 2 to a destination set in advance. The navigation system 7 recognizes a traveling road and a traveling lane on which the vehicle 2 travels, based on the position of the vehicle 2 measured by the GPS receiver 4 and the map information in the map database 6. The navigation system 7 calculates a target route from the position of the vehicle 2 to the destination, and guides the driver to the target route using a human machine interface (HMI).

The actuator 8 is a device that performs a travel control of the vehicle 2. The actuator 8 includes at least an engine actuator, a brake actuator, and a steering actuator. The engine actuator controls driving force of the vehicle 2 by changing an amount of air supplied to the engine (for example, changing the throttle opening) in response to a driving operation or a control signal from the assistance ECU 10 described later. The engine actuator controls the driving force of a motor as a power source when the vehicle 2 is a hybrid vehicle or an electric vehicle.

The notification unit 9 is a device that presents information to the occupants (including the driver) of the vehicle 2. The notification unit 9 includes, for example, a display that displays the information, a speaker that outputs a sound, and the like.

The assistance ECU 10 assists the driving of the vehicle 2. The ECU is an electronic control unit including a central processing unit (CPU), read only memory (ROM), random access memory (RAM), a controller area network (CAN) communication circuit, and the like. The assistance ECU 10 is connected to a network that communicates using, for example, a CAN communication circuit, and is communicatively connected to the above-described configuration elements of the vehicle 2. The assistance ECU 10 operates the CAN communication circuit to input and output the data based on a signal output from the CPU, stores the data in the RAM, loads a program stored in the ROM into the RAM, and then, realizes the assist function by executing the program loaded in the RAM. The assistance ECU 10 may be configured with a plurality of electronic control units. The assistance ECU 10 performs an overall management of the control for assisting the driving of the vehicle 2 traveling toward the arrow type traffic signal.

### Example of Arrow Type Traffic Signal

FIGS. 2A to 2D are examples of lighting of a traffic signal. As illustrated in FIGS. 2A to 2D, a traffic signal 20 includes an arrow lamp 30. The arrow lamp 30 can switch a state to and from a state where an arrow signal 31 is not lit (FIGS. 2A to 2C) and a state where the arrow signal 31 is lit (FIG. 2D). The traffic signal 20 can include not only the arrow lamp 30 but also a lamp 40 that lights a signal which gives an instruction to the vehicle by a color such as red, blue (or green), and yellow. In the example in FIGS. 2A to 2D, the lamp 40 displays a green signal 41, a yellow signal 42 and a red signal 43. The green signal 41 is a signal for permitting the progressing of the vehicle. The yellow signal 42 is a signal which means that the vehicle is prohibited to progress beyond the stop position unless the vehicle cannot stop safely. The red signal 43 is a signal (an example of a stop signal) which means that the vehicle is prohibited to progress beyond the stop position.

The traffic signal 20 is lit in an order of the green signal 41, the yellow signal 42, and the red signal 43. These signals are lit one at a time, not two at a time. The traffic signal 20 starts lighting the arrow signal 31 at the same time as the lighting of the red signal 43 or during the lighting of the red signal 43. The arrow signal 31 has priority over the red signal 43. That is, during the lighting of the red signal 43, the vehicle is permitted to progress only to the pointing direction of the arrow signal 31, and cannot progress to a direction other than the pointing direction of the arrow signal 31, and thus, cannot progress beyond the stop position. The traffic signal 20 ends the lighting of the arrow signal 31 during the lighting of the red signal 43. The traffic signal 20 lights the green signal 41 again when lighting of the red signal 43 ends. In this way, the traffic signal 20 is repeatedly lighting in an order of the green signal 41, the yellow signal 42, and the red signal 43 (red signal 43 and arrow signal 31).

A plurality of arrow signals may be provided for one traffic signal. FIGS. 3A to 3D are examples of lighting of a traffic signal. The traffic signal illustrated in FIGS. 3A to 3D includes a plurality of arrow lamps 30. The traffic signal 20 illustrated in FIG. 3A and FIG. 3B includes a lamp 40 and two arrow lamps 30 and 32. As illustrated in FIG. 3A, when the arrow lamps 30 and 32 do not light the arrow signal, similarly to FIGS. 2A to 2C, the permit for progressing is expressed according to the green signal 41, the yellow signal 42, and the red signal 43. As illustrated in FIG. 3B, when the arrow lamps 30 and 32 are lighting the arrow signal, the arrow signals 31 and 33 have the priority even when the red signal 43 is lit. In the drawings, the arrow signal 31 is a signal that permits rightward progressing, and the arrow signal 33 is a signal that permits straight forward progressing. The traffic signal 20 illustrated in FIG. 3C and FIG. 3D includes a lamp 40 and three arrow lamps 30, 32, and 34. The operation of the traffic signal 20 illustrated in FIG. 3C and FIG. 3D is the same as the operation of the traffic signal 20 illustrated in FIG. 3A and FIG. 3B. In the drawings, the arrow signal 31 is a signal that permits the rightward progressing, the arrow signal 33 is a signal that permits straight forward progressing, and the arrow signal 35 is a signal that permits the leftward progressing.

### Example of Intersection

FIG. 4 is a diagram illustrating an example of an intersection where the traffic signal illustrated in FIGS. 3A to 3D is used. As illustrated in FIG. 4, the vehicle 2 travels on a one-way three-lane road R that merges into the intersection. The road R includes a first lane R1, a second lane R2, and a third lane R3 in order from the left. The first lane is a lane where a left turn and the straight forward progressing are possible, and is provided with a first road surface paint PE1 indicating that left turn and the straight forward progressing are possible. The second lane is a lane where the straight forward progressing, and is provided with a second road surface paint PE2 indicating that the straight forward progressing is permitted. The third lane is a lane where a right turn is permitted, and is provided with a third road surface paint PE3 indicating that the right turn is permitted. At the intersection, the traffic signal 20 is installed so as to display the signal toward the vehicle traveling on the road R.

The green signal 41, the yellow signal 42, and the red signal 43 of the traffic signal 20 are signals that gives instructions to all vehicles traveling on the road R. When the traffic signal 20 lights the green signal 41, all the vehicles traveling on the road R are permitted to progress. When the traffic signal 20 lights the yellow signal 42, all the vehicles traveling on the road R cannot progress beyond the position P1 unless the vehicles can safely stop at the position P1 (an example of the stop position). When the traffic signal 20 lights the red signal 43, all the vehicles traveling on the road R cannot progress beyond the position P1. The vehicle 2 travels so as to approach the traffic signal 20.

### Details of Assistance ECU

Returning to FIG. 1, the assistance ECU 10 includes a light color determination unit 11, a trajectory determination unit 12, a surrounding vehicle state determination unit 13 (an example of a determination unit), an arrow signal recognition unit 14 (an example of a recognition unit), an arrow direction estimation unit 15 (an example of an estimation unit), a comparison unit 16, and an assistance unit 17.

The light color determination unit 11 recognizes the lighting color of the traffic signal. The light color determination unit 11 recognizes a lighting portion of the traffic signal by applying, for example, a pattern matching technology to pixel information obtained by the external sensor 3, and recognizes the lighting color based on the pixel information. In the example in FIG. 4, the light color determination unit 11 recognizes the lighting of the red signal 43 based on the image information of the traffic signal 20.

The trajectory determination unit 12 determines a scheduled progressing direction of the vehicle 2 based on the result of detection performed by the external sensor 3. The scheduled progressing direction is a direction in which the vehicle 2 is scheduled to progress at the intersection where the traffic signal 20 is present, which is a control target in front of the vehicle 2. The trajectory determination unit 12 determines the direction to which the vehicle 2 is scheduled to progress, based on the result of detection of the road surface paint on the lane in which the vehicle 2 travels. In the example in FIG. 4, since the vehicle 2 travels in the third lane R3, the third road surface paint PE3 in the third lane R3 is recognized, and the pointing direction (right turn) of the third road surface paint PE3 is assumed to be set as the scheduled progressing direction. The trajectory determination unit 12 may determine the scheduled progressing direction of the vehicle 2 based on a scheduled path from the navigation system 7. The trajectory determination unit 12 may improve the accuracy of the result of determination by collating the road surface paint with the scheduled path from the navigation system 7.

The surrounding vehicle state determination unit 13 determines a travel state of a surrounding vehicle at the surroundings of the vehicle 2 based on the result of detection performed by the external sensor 3. The travel state is a traveling situation of the vehicle, and includes a travel position, a speed, an acceleration, progressing direction, the stop before the intersection, the passing through the intersection, and the like.

The arrow signal recognition unit 14 recognizes the traffic signal 20 in front of the vehicle 2 based on the result of detection performed by the external sensor 3. In the example in FIG. 4, the arrow signal recognition unit 14 recognizes the lightings of the arrow signals 31, 33, and 35 and the progressing-permitted directions. The arrow signal is a signal whose shape has meaning, and thus, it is difficult to perform the recognition because the display area is smaller than the color signal. Therefore, the arrow signal recognition unit 14 firstly recognizes the lighting of the green signal 41, the yellow signal 42 or the red signal 43 as the vehicle 2 comes close to the traffic signal 20. At the same timing as the recognition timing of the color signal, or at the timing when the vehicle 2 comes closer to the traffic signal 20 (position P3 that is a position away from the traffic signal 20 by a distance L1), the arrow signal recognition unit 14 recognizes the lighting of the arrow signals 31, 33, and 35. At the position P3, the arrow signal recognition unit 14 cannot recognize the progressing-permitted direction of the arrow signal 31. At the timing when the vehicle 2 comes closer to the traffic signal 20 from the position P3 at which the lighting of the arrow signal 31 is recognized (the position P2 that is a position away from the traffic signal 20 by a distance L2), the arrow signal recognition unit 14 recognizes the progressing-permitted direction of the arrow signals 31, 33, and 35.

The arrow direction estimation unit 15 estimates the progressing-permitted direction of the arrow signal based on the result of determination performed by the surrounding vehicle state determination unit 13. That is, the arrow direction estimation unit 15 estimates the progressing-permitted direction of the arrow signal based on a behavior of the surrounding vehicle. The progressing-permitted direction of the arrow signal affects the behavior of the vehicle traveling on the road R. Therefore, it may be possible to estimate the progressing-permitted direction of the arrow signal from the behavior of the vehicle traveling on the road R.

In the example in FIG. 4, the arrow direction estimation unit 15 estimates the progressing-permitted direction of the traffic signal 20 based on the number of road lanes in which the vehicle 2 travels, the number of lightings of the traffic signal 20, and the travel state of surrounding vehicles 2A and 2B. For example, it is assumed that the number of road lanes is 3, the red signal 43 is lit, the travel state of the surrounding vehicles 2A and 2B is a stop state before the intersection, and one arrow signal is lit. In this case, the arrow signal that is lit can be estimated to be a signal (permit for progressing to the right direction) to the vehicle traveling in the third lane R3. Alternatively, if the travel state of the surrounding vehicles 2A and 2B is passing through the intersection and the number of arrow signal that is lit is one, the arrow signal that is lit can be estimated to be a signal (permit for straight forward progressing) to the vehicle traveling in the first lane R1 and the second lane R2. As described above, the arrow direction estimation unit 15 estimates the progressing-permitted direction of the traffic signal 20 based on the number of road lanes, the number of lightings of the arrow signal, and the travel states of the surrounding vehicles 2A and 2B. The estimation method is not limited to these, and the number of road lanes, the number of lightings of the traffic signals 20 and the travel states of surrounding vehicles 2A and 2B may be input, the progressing-permitted direction of the arrow signal may be estimated using a model learned by the machine learning.

The comparison unit 16 compares the progressing-permitted direction recognized by the arrow signal recognition unit 14 with the scheduled progressing direction of the vehicle 2. The arrow signal recognition unit 14 recognizes the progressing-permitted directions of the arrow signals 31, 33, and 35 at a position P2 which is a position away from the traffic signal 20 by the distance L2. Therefore, the result of estimation of the progressing-permitted direction is compared with the scheduled progressing direction of the vehicle 2 before the vehicle 2 reaches the position P2. The comparison unit 16 compares the progressing-permitted direction with the scheduled progressing direction, and determines whether the directions are the same direction or different directions.

The assistance unit 17 assists the driving of the vehicle 2. The assistance unit 17 acquires the result of detection performed by the internal sensor 5, that is, the travel state of the vehicle 2. The assistance unit 17 acquires the current speed, acceleration, traveling position, and the like of the vehicle 2 as an example.

The assistance unit 17 determines a content of the driving assistance of the vehicle 2 based on the result of comparison performed by the comparison unit 16, and operates at least one of the actuator 8 and the notification unit 9 based on the travel state of the vehicle 2 and the content of the assistance. The driving assistance includes at least one of a deceleration assistance and a notification assistance. The deceleration assistance is an assistance that causes the actuator 8 to operate in response to the signal of the traffic signal 20 to decelerate the vehicle 2. The notification assistance is an assistance that causes the notification unit 9 to operate according to the signal of the traffic signal 20 and urges the deceleration of the vehicle 2 according to the lighting state of the traffic signal. The notification assistance includes at least one of the assistance to display a deceleration display that urges the deceleration of the vehicle 2 and the assistance to output a sound that urges the deceleration of the vehicle 2.

The assistance unit 17 starts the driving assistance at the timing when the lighting of the arrow signal is recognized. In the example in FIG. 4, the lighting of the arrow signal 31 is recognized at the position P3. Although the lighting of the arrow signal 31 is recognized, the progressing-permitted direction is uncertain. In this case, the progressing-permitted direction estimated by the arrow direction estimation unit 15 is compared with the progressing scheduled direction of the vehicle 2, and the content of the driving assistance is determined based on the result of comparison.

In the example in FIG. 4, the arrow signals 31, 33, and 35 are lit when the red signal 43 is lit. Therefore, when the lighting of the arrow signals 31, 33, and 35 is recognized by the arrow signal recognition unit 14, the red signal 43 is also lit. In this case, when the progressing-permitted direction of the arrow signal 31 which is identified later coincides with the scheduled progressing direction of vehicle 2, the vehicle 2 is permitted to progress to the progressing-permitted direction of the arrow signal 31 even if the red signal 43 is lit. When the progressing-permitted direction of the arrow signal 31 which is identified later does not coincide with the scheduled progressing direction of vehicle 2, the vehicle 2 needs to follow the lighting of the red signal 43. In this case, the vehicle 2 is not permitted to progress beyond the position P1 and needs decelerate so as not to progress beyond the position P1. That is, in the example in FIG. 4, as actions that can be taken when the progressing-permitted direction is identified, two patterns are assumed: a pattern in which the vehicle 2 progresses to the progressing-permitted direction and a pattern in which the vehicle 2 decelerates.

Even though the progressing-permitted direction of the arrow signal 31 is uncertain at position P3, the assistance unit 17 starts at least one of the deceleration assistance and the notification assistance using the progressing-permitted direction of the arrow signal 31 predicted from the behaviors of the surrounding vehicles 2A and 2B. The deceleration assistance and the notification assistance started based on the prediction as described above will be referred to as a second assistance hereinafter. The assistance unit 17 starts the second assistance when the vehicle positions at the position P3 and continues the assistance until the vehicle 2 reaches the position P2. That is, the assistance unit 17 starts the second assistance from the lighting of the arrow signal 31 and performs the assistance until the progressing-permitted direction of the arrow signal 31 is recognized by the arrow signal recognition unit 14.

When the vehicle 2 reaches the position P2 and the progressing-permitted direction of the arrow signal 31 is recognized by the arrow signal recognition unit 14, the comparison unit 16 determines whether or not the progressing-permitted direction of the arrow signal 31 coincides with the scheduled progressing direction of the vehicle 2. If the progressing-permitted direction of arrow signal 31 coincides with the scheduled progressing direction of vehicle 2, because the vehicle is permitted to progress, the assistance unit 17 performs the driving assistance for passing. If the progressing-permitted direction of arrow signal 31 does not coincide with the scheduled progressing direction of vehicle 2, the assistance unit 17 performs the driving assistance including at least one of the deceleration assistance and the notification assistance. The deceleration assistance performed based on the progressing-permitted direction detected by the external sensor 3 as described above is referred to as a first assistance.

### Operation Performed by Driving Assistance Apparatus

FIG. 5 is a flowchart illustrating an example of the operation performed by the driving assistance apparatus. The flowchart illustrated in FIG. 5 is performed by the assistance ECU 10 of the driving assistance apparatus 1. The assistance ECU 10 starts the processing when the assistance start button is turned on by the operation by the occupant. The operation in the travel scene illustrated in FIG. 4 performed by the driving assistance apparatus will be described below.

As illustrated in FIG. 5, as traffic signal recognition processing (step S1), the assistance ECU 10 recognizes the traffic signal 20 existing in front of the vehicle 2 based on the result of detection performed by the external sensor 3. Subsequently, as red signal determination processing (step S2), the assistance ECU 10 determines whether or not the red signal 43 is recognized by the light color determination unit 11.

If it is determined by the light color determination unit 11 that the lighting of the red signal 43 is not recognized (NO in step S2), as assistance performing processing (step S10), the assistance unit 17 performs the driving assistance which is performed when the vehicle is permitted to enter the intersection. As an example, the assistance unit 17 gives a notification of a fact that the vehicle 2 is permitted to enter the intersection. When the assistance performing processing (step S10) ends, the flowchart illustrated in FIG. 5 ends.

When it is determined by the light color determination unit 11 that the red signal 43 is recognized (YES in step S2), as the lighting signal recognition process (step S3), the assistance ECU 10 determines whether or not the arrow signal recognition unit 14 recognizes the lighting of the arrow signal 31.

If it is determined by the arrow signal recognition unit 14 that the lighting of the arrow signal 31 is not recognized (NO in step S3), as the assistance performing processing (step S1), the assistance unit 17 performs the driving assistance which is performed when the vehicle is not permitted to enter the intersection. For example, the assistance unit 17 calculates the deceleration based on the distance to the traffic signal 20 and the current vehicle speed, and starts the deceleration at the calculated deceleration so as not to progress beyond position P1. If the state in which the arrow signal 31 is not lighting continues during the lighting of the red signal 43, the assistance is continuously performed while the deceleration is adjusted, and then, the vehicle 2 is decelerated so as not to exceed the position P and finally stops. If the assistance performing processing (step S1) ends, the flowchart illustrated in FIG. 5 ends.

Here, if it is determined by the arrow signal recognition unit 14 that the lighting of the arrow signal 31 is recognized (YES in step S3), as direction recognition processing (step S4), the assistance unit 17 determines whether or not the direction of the arrow signal 31 is recognized by the arrow signal recognition unit 14.

If it is determined that the direction of the arrow signal 31 is recognized by the arrow signal recognition unit 14 (YES in step S4), as trajectory estimation processing (step S8), the trajectory determination unit 12 determines the scheduled progressing direction (trajectory) of the vehicle 2 based on the third road surface paint PE3 or the like. Then, as determination processing (step S9), the comparison unit 16 determines whether or not the direction of the arrow signal 31 is the scheduled progressing direction.

If it is determined that the direction of the arrow signal 31 is the scheduled progressing direction (YES in step S9), since the vehicle 2 is permitted to progress, the assistance unit 17 performs the above-described assistance performing processing (step S10), and ends the flowchart illustrated in FIG. 5. If it is determined that the direction of the arrow signal 31 is not the scheduled progressing direction (NO in step S9), since the vehicle 2 is not permitted to progress, the assistance unit 17 performs the above-described assistance performing processing (step S11), and the flowchart illustrated in FIG. 5 ends. As described above, the vehicle 2 performs any one of actions: either progresses according to the arrow signal 31 or decelerates according to the red signal 43 under the first assistance because the direction of the arrow signal 31 is not the scheduled progressing direction.

Here, if it is determined by the arrow signal recognition unit 14 that the direction of the arrow signal 31 is not recognized (NO in step S4), as recognition processing (step S5) the surrounding vehicle state determination unit 13 recognizes the surrounding vehicle in front of the vehicle 2. As an example, the surrounding vehicle state determination unit 13 recognizes whether the surrounding vehicle of the vehicle 2 is passing through the intersection or the surrounding vehicle of the vehicle 2 is stopped before the intersection based on the result of detection performed by the external sensor 3.

Subsequently, as determination processing (step S6), the assistance ECU 10 determines whether or not the vehicle 2 is permitted to enter the intersection based on the travel state of the surrounding vehicle. Firstly, arrow direction estimation unit 15 of the assistance ECU 10 estimates the progressing-permitted direction of the traffic signal 20 based on the number of road lanes in which the vehicle 2 travels, the number of lightings of the traffic signal 20, and the travel state of the surrounding vehicles 2A and 2B. Then, the comparison unit 16 compares the progressing-permitted direction estimated by the arrow direction estimation unit 15 with the scheduled progressing direction of the vehicle 2. In this way, it is determined whether or not the vehicle 2 is permitted to enter the intersection. For example, if the traveling road of the vehicle 2 has two lanes, one arrow signal is lit, and the surrounding vehicle is stopped before the intersection in the adjacent lane of the vehicle 2, it is determined that vehicle 2 is permitted to enter the intersection. For example, if the traveling road of vehicle 2 has 3 lanes, one arrow signal is lit, and both the surrounding vehicles in two adjacent lanes of the vehicle 2 are stopped before the intersection, it is determined that the vehicle 2 is permitted to enter the intersection.

If it is determined that the vehicle 2 is permitted to enter the intersection (YES in step S6), the above-described assistance performing processing (step S10) is performed, and the flowchart illustrated in FIG. 5 ends. If it is determined that the vehicle 2 is not permitted to enter the intersection (NO in step S6), as the determination processing (step S7), the assistance ECU 10 determines whether the vehicle 2 is not permitted to enter the intersection based on the travel state of the surrounding vehicle. For example, if the traveling road of the vehicle 2 has two lanes, one arrow signal is lit, and the surrounding vehicle in the adjacent lane of vehicle 2 passes through the intersection, it is determined that the vehicle 2 is not permitted to enter the intersection. For example, if the traveling road of vehicle 2 has 3 lanes, one arrow signal is lit, and one of the surrounding vehicles in the two adjacent lanes of vehicle 2 passes the intersection, it is determined that the vehicle 2 is permitted to enter the intersection.

If it is determined that the vehicle 2 is not permitted to enter the intersection (YES in step S7), the above-described assistance performing processing (step S11) is performed, and the flowchart illustrated in FIG. 5 ends. If it is determined that it is not possible to say that the vehicle 2 is not permitted to enter the intersection (NO in step S7), in the current travel scene, it is a situation in which it cannot be concluded that the vehicle 2 is permitted to enter the intersection, nor is not permitted to enter the intersection. Therefore, the process is shifted to the direction recognition processing (step S4), and steps S4 to S7 are repeatedly performed until it becomes possible to conclude whether the vehicle is permitted to enter the intersection or not.

### Summary of Embodiment

In the driving assistance apparatus 1, the lighting of the arrow signals 31, 33, and 35 and the progressing-permitted direction are recognized by the arrow signal recognition unit 14. The progressing-permitted direction and the scheduled progressing direction of the vehicle are compared by the comparison unit 16. The driving assistance is performed by the assistance unit 17 based on the result of comparison. However, in some cases, the arrow signal recognition unit 14 can recognize the lighting of the arrow signals 31, 33, and 35, but cannot recognize the progressing-permitted direction of the arrow signals 31, 33, and 35. Therefore, if the lighting of the arrow signals 31, 33, and 35 is recognized and the progressing-permitted direction is not recognized, the progressing-permitted direction estimated by the arrow direction estimation unit 15 and the scheduled progressing direction of the vehicle 2 are compared by the comparison unit 16. The travel state of the surrounding vehicle of the vehicle 2 is determined by the surrounding vehicle state determination unit 13 based on the result of detection performed by the external sensor 3. The progressing-permitted direction of the traffic signal 20 is estimated by the arrow direction estimation unit 15 based on the result of determination performed by the surrounding vehicle state determination unit 13. In this way, even if the progressing-permitted direction is not recognized, the driving assistance apparatus 1 predicts the progressing-permitted direction of the arrow signals 31, 33, 35 based on the travel state of the surrounding vehicle, and can perform the driving assistance based on the result of prediction. Therefore, the driving assistance apparatus 1 can expedite a timing of the assistance compared to a case where the assistance is performed from the timing at which the progressing-permitted directions of the arrow signals 31, 33, 35 are recognized. Furthermore, the driving assistance apparatus 1 can reduce a case where the performed assistance becomes an unnecessary assistance as a result compared to the case where the assistance is performed without taking the progressing-permitted direction of the arrow signals 31, 33, and 35 into consideration. Accordingly, the driving assistance apparatus 1 can reduce the inconvenience to the occupant.

Various exemplary embodiments have been described above, but various omissions, substitutions, and changes may be made without being limited to the exemplary embodiments described above. For example, the driving assistance apparatus 1 may not include the light color determination unit 11 and the trajectory determination unit 12.

What is claimed is:

1. A driving assistance apparatus that assists driving of a vehicle that is traveling toward an arrow type traffic signal, comprising:
a recognition unit configured to recognize a lighting and a progressing-permitted direction of the arrow type traffic signal based on a result of detection performed by an external sensor that detects information on an external environment of the vehicle;
a comparison unit configured to compare the progressing-permitted direction recognized by the recognition unit with a scheduled progressing direction of the vehicle;
an assistance unit configured to perform a driving assistance based on a result of comparison performed by the comparison unit;
a determination unit configured to determine a travel state of a surrounding vehicle of the vehicle based on a result of detection performed by the external sensor; and
an estimation unit configured to estimate the progressing-permitted direction of the arrow type traffic signal based on a result of determination performed by the determination unit,
wherein the comparison unit is configured to compare the progressing-permitted direction estimated by the estimation unit and the scheduled progressing direction of the vehicle, when the lighting of the arrow type traffic signal is recognized by the recognition unit and the progressing-permitted direction is not recognized.

2. The driving assistance apparatus according to claim 1,
wherein the estimation unit is configured to estimate the progressing-permitted direction of the arrow type traffic signal based on the number of road lanes on a road on which the vehicle travels, the number of lightings of the arrow type traffic signal, and the travel state of the surrounding vehicle.
